(19) United States
(12) Patent Application Publication
(10) Pub. No.: US 2005/0126587 A1
(43) Pub. Date: Jun. 16, 2005

(54) Method of cleaning a steam generator of a pressurized water reactor

(75) Inventors: Konrad Bitter, Herzogenaurach (DE); Ursula Hollwedel, Schnaittach (DE); Silvia Schuss, Feldkirchen (DE)

Correspondence Address: LERNER AND GREENBERG, PA, P O BOX 2480, HOLLYWOOD, FL, 33022-2480, US

(73) Assignee: Framatome ANP GmbH

(21) Appl. No.: 11/044,886

(22) Filed: Jan. 27, 2005

Related U.S. Application Data
(63) Continuation of application No. PCT/EP03/09171, filed on Aug. 19, 2003.

(30) Foreign Application Priority Data
Aug. 23, 2002 (DE) 102 38 730.3

(51) Int. Cl. B08B 7/00

(52) U.S. Cl. 134/2; 134/19

(57) ABSTRACT

A method for cleaning steam generating devices of a pressurized water reactor treats the devices on their secondary sides at high pressure and high temperature. An aqueous cleaning solution is employed with EDTA, a reducing agent, and an alkalizing agent. Morpholine is used as the alkalization agent. A molar morpholine-concentration, which is at least as great as the molar concentration of EDTA, is selected. Hydrazine and/or formaldehyde are/is used as the reducing agent at a ratio to EDTA between 1:6 and 1:1.

### CROSS-REFERENCE TO RELATED APPLICATION

This is a continuing application, under 35 U.S.C. § 120, of copending international application No. PCT/EP2003/009171, filed Aug. 19, 2003, which designated the United States; this application also claims the priority, under 35 U.S.C. § 119, of German patent application No. 102 38 730.3, filed Aug. 23, 2002; the prior applications are herewith incorporated by reference in their entirety.

### BACKGROUND OF THE INVENTION

Field of the Invention

The invention lies in the field of pressurized water reactor (PWR) technology. More specifically, the invention relates to a method of cleaning the steam generator of a pressurized water reactor.

A steam generator of a pressurized water reactor usually comprises a vessel in whose lower region a large number of, for example, U-shaped heat exchanger tubes through which primary coolants flow are disposed. In the upper region of the vessel, there are further internal fittings such as steam separators and steam dryers. While the heat exchanger tubes comprise corrosion-resistant alloys, the vessel, auxiliary structures serving to fix the heat exchanger tubes and parts of the secondary circuit through which secondary coolants flow are partly made of materials having a lower corrosion resistance, for example carbon steel. Those parts, therefore, subject to corrosion at the operating temperatures which prevail.

During operation, corrosion products, mainly magnetite, are formed in the secondary circuit and go into the steam generator where they deposit on the bottom of the vessel and in spacers between tubes and grow as a coating on the surface of the heat exchanger tubes. To ensure the integrity and satisfactory performance of steam generators, in particular unhindered heat transfer, cleaning work is, if necessary, carried out during annual maintenance in order to remove the sludge formed by the deposits and the coating on the heat exchanger tubes by chemical means.

For this purpose, the steam generator is filled stepwise with cleaning liquid until the exchanger tubes are fully immersed. A conventional cleaning solution known, for example, from U.S. Pat. No. 4,632,705 comprises a complexing acid such as ethylenediaminetetraacetic acid (EDTA), a reducing agent, for example hydrazine, and ammonia as alkalizing agent. Alkaline conditions are necessary in order to keep dissolution of material from the parts of the secondary circuit which consists of carbon steel or low-alloy steels as low as possible. In addition, a corrosion inhibitor is added for this purpose. In the case of a method which is known from German published patent application DE 198 57 342 and likewise employs hydrazine as reducing agent, morpholine (tetrahydro-1,4-oxazine) is used as alkalizing agent. Morpholine is significantly less volatile than ammonia, so that only a correspondingly smaller proportion goes into the vapor phase. In cleaning methods of the present type, the usual procedure is to carry out a sudden depressurization via valves of the fresh steam system located downstream of the steam generator at particular time intervals, leading to vigorous boiling and strong turbulence in the cleaning liquid. In this way, the cleaning solution is mixed so that the complexing agent can dissolve the magnetite after reduction. Since the proportion of morpholine in the vapor phase is significantly lower than that of ammonia, significantly less environmentally polluting alkalizing agent gets into the environment on depressurization than in the case of methods employing ammonia. In terms of the cleaning method, the small loss of alkalizing agent has the significant advantage that the pH remains virtually constant to the end of cleaning. This results in dissolution of metal of construction being reduced compared to methods employing ammonia in which, owing to the loss of ammonia, the pH drops to values close to neutral toward the end of the cleaning time.

### SUMMARY OF THE INVENTION

It is accordingly an object of the invention to provide a method for cleaning the steam generator of a pressurized water nuclear reactor which overcomes the above-mentioned disadvantages of the heretofore-known devices and methods of this general type and which renders possible effective cleaning with further reduced dissolution and erosion of structural metal without the addition of a corrosion inhibitor.

With the foregoing and other objects in view there is provided, in accordance with the invention, a method of cleaning a steam generator of a pressurized water reactor, which comprises:
treating the steam generator on a secondary side thereof under super-atmospheric pressure and at elevated temperature with an aqueous cleaning solution comprising EDTA, a reducing agent, and morpholine as alkalizing agent;
the cleaning solution having:
   a molar morpholine concentration at least as great as a molar concentration of EDTA; and
   the reducing agent selected from the group consisting of hydrazine and formaldehyde; and
   a ratio of hydrazine and/or formaldehyde to EDTA from 1:6 to 1:1.

It has surprisingly been found that the use of a cleaning solution in which the molar morpholine concentration is at least as great as the molar concentration of EDTA makes it possible to achieve more gentle cleaning, i.e., cleaning which is less aggressive toward of the structural metals, compared to ammonia methods.

The absolute concentrations of the specified constituents in the cleaning solution naturally depend on the amount of deposit to be removed in each case, so that these may be present in relatively high concentrations. The above-mentioned gentler cleaning effect is nevertheless observed when morpholine is present in a molar concentration which is the same as or greater than that of EDTA.

The molar ratio of morpholine to EDTA lies in the range from 1:1 to 6:1. Optimal results are achieved when it is 4:1. The latter molar ratio corresponds to a mass ratio of 1.2. A particularly good cleaning action is achieved when the molar ratio of reducing agent (hydrazine and/or formaldehyde) to EDTA is in the range from 1:6 to 1:1. Preference is given to a molar ratio of 1:3 (hydrazine:EDTA), which corresponds to a mass ratio of 0.04. Apart from the particularly preferred hydrazine, formaldehyde is also a preferred reducing agent.

In accordance with a concomitant feature of the invention, the cleaning is performed while a temperature of from 140° C. to 200° C. is maintained.

Other features which are considered as characteristic for the invention are set forth in the appended claims.

Although the invention is described herein as embodied in a method of cleaning the steam generator of a pressurized water reactor, it is nevertheless not intended to be limited to the exemplary details, since various modifications and structural changes may be made therein without departing from the spirit of the invention and within the scope and range of equivalents of the claims.

The implementation of the method according to the invention, however, together with additional objects and advantages thereof, will be best understood from the following description of a specific exemplary embodiment.

### EXAMPLE

A cleaning solution suitable for cleaning a steam generator comprises 60 g/l of EDTA (=0.205 mol/l), 71.5 g/l of morpholine (=0.821 mol/l) and 2.2 g/l of hydrazine (=0.068 mol/l). Such a solution has a pH of about 9. The molar ratio of morpholine to EDTA is thus 4:1, and that of hydrazine to EDTA is 1:3.

A preferred variant of the method provides for cleaning to be carried out during running-down of the reactor. As soon as the temperature in the steam generator is about 160° C., the constituents of the solution are introduced in concentrated form in such an amount that the above-mentioned concentrations are obtained after addition of water. The pressure in the steam generator is, depending on the cleaning temperature, from about 6 to 10 bar. The cleaning solution is brought to boiling by means of sudden depressurizations distributed over the entire cleaning time, so that unconsumed chemicals come into contact with the deposits. Below about 140° C., cleaning can no longer be carried out effectively.

To examine the effectiveness of cleaning solutions employing morpholine in comparison with ammonia when using the same method, the tests described below were carried out:

In a laboratory autoclave made of stainless steel, 11.5 g of magnetite sludge having an iron content of 72.5% by weight from the steam generator of a pressurized water plant were treated with about 1 l of the above-described cleaning solution at a temperature of 160° C. for 8 hours, with sudden depressurizations being carried out a number of times in order to achieve intimate mixing. The water removed during the course of evaporation and the cleaning solution removed from the autoclave for sampling purposes were fed in again. Coupons of carbon steel were positioned below the surface of the liquid by means of a Teflon-coated suspending device located in the autoclave.

Two experiments were carried out under these conditions, with ammonia/EDTA being employed in one case and morpholine/EDTA being employed in the other case and the respective alkalizing agent being metered in so that a pH of 9 was established. As a result of the cleaning liquid taken off being fed back in again, this value remains virtually constant to the end of cleaning so that the above-described effect of increased attack on the metal of construction as a result of the reduction in pH was suppressed. At the end of the experiments, the amount of iron dissolved from the coupons and from the sludge was determined. In both cases, the ratio of dissolved sludge to initial amount of sludge was found to be 95%. Both cleaning solutions exhibited a comparable effect in respect of the dissolution of magnetite sludge. However, while the proportion of iron dissolved from the carbon steel coupon in the experiment using ammonia was 20%, this proportion was only 15% in the morpholine experiment. The corrosion action on the carbon steel was thus lower in the case of the cleaning solution containing morpholine. In the cleaning test using ammonia, an average of 27 μm of material was removed, which corresponds to an average dissolution rate of 34 g/l*h*m². In the morpholine experiment, an average removal of material of 21 μm or an average dissolution rate of 20 g/l*h*m² was observed. Since the pH was kept virtually constant in both cases, the poorer result of the ammonia experiment cannot be attributed to a reduction in the pH. Rather, an effect resulting from the combination EDTA/morpholine appears to be present.

Differential thermal analyses carried out by us on ammonia/EDTA and morpholine/EDTA indicates a greater thermal stability of the system morpholine/EDTA when the specified molar ratios are adhered to. It is known that EDTA decomposes at relatively high temperatures, forming corrosive decomposition products, for example iminodiacetic acid. This problem has hitherto been countered by a shortened cleaning time or by a reduced cleaning temperature. The disadvantages which result from this are obvious. On the other hand, wider time windows can be exploited in the method proposed. Furthermore, cleaning at temperatures above 180° C. should also be possible because of the higher thermal stability of morpholine/EDTA.

1. A method of cleaning a steam generator of a pressurized water reactor, which comprises:
treating the steam generator on a secondary side thereof under super-atmospheric pressure and at elevated temperature with an aqueous cleaning solution comprising EDTA, a reducing agent, and morpholine as alkalizing agent;
the cleaning solution having:
a molar morpholine concentration at least as great as a molar concentration of EDTA; and
the reducing agent selected from the group consisting of hydrazine and formaldehyde; and
a ratio of hydrazine and/or formaldehyde to EDTA from 1:6 to 1:1.

2. The method according to claim 1, which comprises using a cleaning solution with morpholine and EDTA present in a molar ratio of from 1:1 to 6:1.

3. The method according to claim 2, wherein the molar ratio of morpholine to EDTA is 4:1.

4. The method according to claim 1, which comprises using hydrazine as the reducing agent.

5. The method according to claim 1, which comprises using formaldehyde as the reducing agent.

6. The method according to claim 1, which comprises setting the molar ratio of reducing agent to EDTA at 1:3.

7. The method according to claim 1, which comprises maintaining a temperature of from 140° C. to 200° C. during cleaning.
